(19) United States
(12) Patent Application Publication
(10) Pub. No.: US 2015/0244896 A1
(43) Pub. Date: Aug. 27, 2015

(54) SYSTEM AND METHOD FOR DIGITAL SIGNAL COMPRESSION

(71) Applicant: Vor Data Systems, Inc., San Diego, CA (US)

(72) Inventor: Brons Larson, San Diego, CA (US)

(73) Assignee: Vor Data Systems, Inc.

(21) Appl. No.: 14/619,605

(22) Filed: Feb. 11, 2015

Related U.S. Application Data
(60) Provisional application No. 61/944,833, filed on Feb. 26, 2014.

(51) Int. Cl. H04N 1/32; G06T 1/00

(52) U.S. Cl. CPC H04N 1/32277; G06T 1/0021; H04N 1/32187; H04N 1/3216; H04N 1/32352

(57) ABSTRACT

A system and method for digital signal compression, segmentation and steganography. Application of a continuous boundary local trigonometric transform (CBLTT) provides analysis of a signal in a localized manner. The CBLTT decomposes the signal into regions that are assumed to be independent of one another that then undergo an invertible, nonlinear transformation and is projected onto an orthogonal basis.

### CROSS-REFERENCE TO RELATED APPLICATIONS

This application claims the benefit of priority of U.S. Provisional application Ser. No. 61/944,833, filed on Feb. 26, 2014, which is incorporated herein by reference.

### BACKGROUND OF THE INVENTION

The visual world is full of textures and structures that may be described as pseudo-periodic. From man-made objects such as shingle roofs, brick walls or striped clothing, to natural or biological objects such as trees, grass or blown sand, these pseudo-periodicities abound at many scales. Neuroscience teaches that the mammalian visual system processes visual information in a localized, patch-by-patch manner. The main benefit of this type of decomposition is that visual information is more efficiently represented. Mathematical models and transform algorithms have been developed to mimic this type of behavior in order to decrease the representation cost of a dataset to improve analysis and compression. Transform algorithms include the Discrete Cosine Transform (DCT) used in JPEG (JPEG-DCT), the Wavelet Transform (WT), the Wavelet Packets (WP), the Local Trigonometric Transforms (LTT), and the Brushlet Transform (BT).

These methods provide techniques for localizing both a signal and its frequency content. In addition, the Local Fourier Transform (LFT) and the Brushlet Transform are equipped with a phase. But all of these approaches suffer from a crucial problem of how to effectively treat the initial signal to provide boundary conditions which match those of bases associated with each particular transform. Without any information outside of the original interval, there lacks an effective way to both provide proper boundary conditions matching the associated transform bases, and also recover the original signal from the transformed coefficients in a stable manner. Furthermore, many of these methods operate by folding, or mixing, information between adjacent intervals. Instability of this folding process on or near an edge can increase edge effects which translate recursively to all lower levels of the transform. This can result in inefficient representation, improper segmentation and incorrect analysis of the signal.

### SUMMARY OF THE INVENTION

The present invention provides localized analysis based on a Continuous Boundary Local Trigonometric Transform (CBLTT) that corrects the shortcomings of the LTT. The LTT projects a signal onto smooth overlapping basis functions, whereas the CBLTT decomposes the signal into regions that are assumed to be independent of one another. Each independent subspace then undergoes an invertible, nonlinear transformation to reduce an edge effect, and is immediately projected onto an orthogonal basis; e.g., Fourier basis, Sine/Cosine basis, Wavelet basis. As a tensor product, it can be applied to multi-dimensional data; e.g., signals, images, video. This method efficiently segments the frequency domain of a signal, and generates a new version of the Brushlet Transform. This new class of transforms has many applications ranging from compression to segmentation to steganography, for example. The application of this new class of transforms to steganography and other applications is disclosed, described, and claimed herein.

One embodiment of the invention is a method for digital signal compression executed by a processor including the steps of: a) applying a first extension to a first boundary and a second extension to a second boundary of a global subspace of a signal; b) performing isometric folding at the first boundary and the second boundary of the subspace; c) discarding the first extension and the second extension of the subspace; d) scaling the subspace; e) applying a discrete transform to the subspace to generate a transformed subspace; f) storing the transformed subspace in a best basis tree; g) halving the scaled subspace of step d) into a first half subspace and a second half subspace; h) recursively repeating steps a) through f) on the first half subspace and the second half subspace; and i) applying a metric for a best basis algorithm performed on the best basis tree when a bottom of the best basis tree is reached.

The folding may be performed at a gridpoint or a midpoint. The discrete transform is DST-IV using sine polarity or DCT-IV using cosine polarity. The folding is full, fixed or multiple. Periodized folding may be performed with a fast Fourier transform after step d). A complex valued or a real-valued fast Fourier transform may be applied to the signal before step a). The best basis metric includes sparsity and entropy. The discrete transform is one of DCT-I, DCT-II, DCT-III, DST-1, DST-II, DST-III and the folding is mixed polarity or hybrid polarity. Step b) performs shift isometric folding. One of the first extension and the second extension is used in folding and unfolding. The first extension and the second extension, a shift value of the isometric folding, and a scale value of the scaling may be stored. The isometric folding includes a folding operator determined as a function of a rising cutoff function.

A result of step i) may be applied as a tensor product to higher dimensional data. The higher dimensional data includes at least one of audio, image and video data. An inverse operation may be performed to each of steps a) through i). A predetermined set of transform coefficients of the transformed subspace are discarded and a remaining set of the transform coefficients are used to invert the transformed subspace to reconstruct a compressed version of the digital signal.

In another embodiment, a method for embedding hidden data into an object includes: a) applying a first extension to a first boundary and a second extension to a second boundary of a global subspace of a digital signal of the object; b) performing isometric folding at the first boundary and the second boundary of the subspace; c) discarding the first extension and the second extension of the subspace; d) scaling the subspace; e) applying a discrete transform to the subspace to generate a transformed subspace; f) modifying transform coefficients of the transformed subspace to include the hidden data such that transforming the modified transform coefficients generates a modified digital signal; g) storing the transformed subspace in a best basis tree; h) halving the scaled subspace of step d) into a first half subspace and a second half subspace; i) recursively repeating steps a) through f) on the first half subspace and the second half subspace; and j) applying a metric for a best basis algorithm performed on the best basis tree when a bottom of the best basis tree is reached. Non-limiting examples of an object into which hidden data may be embedded include printed media, clothing, metal objects, audio data, image data, video data, webpages, product packaging, product hang-tags, wristbands, blister packaging, machine parts, billboards, and window tint.

In yet another embodiment, a method of extracting hidden data in an object by a device includes capturing an image of the object, converting the image to a digital signal, and includes: a) applying a first extension to a first boundary and a second extension to a second boundary of a global subspace of a digital signal of the image of the object; b) performing isometric folding at the first boundary and the second boundary of the subspace; c) discarding the first extension and the second extension of the subspace; d) scaling the subspace; e) applying a discrete transform to the subspace to generate a transformed subspace; f) storing the transformed subspace in a best basis tree; g) halving the scaled subspace of step d) into a first half subspace and a second half subspace; h) recursively repeating steps a) through f) on the first half subspace and the second half subspace; applying a metric for a best basis algorithm performed on the best basis tree when a bottom of the best basis tree is reached; and extracting the hidden data from the transformed subspace. The device may be, for example, a mobile device.

These and further embodiments are described in the following detailed description and examples.

### BRIEF DESCRIPTION OF THE DRAWINGS

In order to understand the invention and to see how it may be carried out in practice, embodiments will now be described, by way of non-limiting example only, with reference to the accompanying drawings, in which:

FIG. 1 sets forth graphs illustrating a folding operator in an implementation of the present invention.

FIG. 2 is a graph illustrating a rising cutoff function in an implementation of the present invention.

FIG. 3 sets forth graphs illustrating an unfolding operator in an implementation of the present invention.

FIG. 4 sets forth graphs illustrating periodization in an implementation of the present invention.

FIG. 5 sets forth graphs illustrating extensions in an implementation of the present invention.

FIG. 6 sets forth graphs illustrating periodization in an implementation of the present invention.

FIGS. 7A-7B sets forth images illustrating compression in an implementation of the present invention.

FIG. 8 is a conceptual diagram illustrating an implementation of the present invention of a system for embedding and retrieving hidden information.

FIG. 9 is a conceptual diagram illustrating an implementation of the present invention of a system for embedding and retrieving hidden information.

FIG. 10 are images illustrating analytics associated with the retrieved hidden information.

FIG. 11 is a conceptual diagram illustrating an implementation of the present invention of supply chain tracking and authentication.

FIG. 12 is a conceptual diagram illustrating an implementation of the present invention of authentication of a blister pack.

FIG. 13 is a conceptual diagram illustrating an implementation of the present invention of hidden data in printed media.

FIG. 14 is a conceptual diagram illustrating an implementation of the present invention of hidden data on a display device.

FIG. 15 is a conceptual diagram illustrating an implementation of the present invention of hidden data within a product hang-tag.

FIG. 16 is a conceptual diagram illustrating an implementation of the present invention of hidden data within a clothing article.

FIG. 17 is a conceptual diagram illustrating an implementation of the present invention of hidden data within printed media.

FIG. 18 is a conceptual diagram illustrating an implementation of the present invention of hidden data within identification badges.

FIG. 19 is a conceptual diagram illustrating an implementation of the present invention of hidden data within printed media.

### DETAILED DESCRIPTION OF THE INVENTION

Particular embodiments of the invention will now be described in detail with reference to the accompanying drawings. In the following description, specific details are set forth in order to provide a sufficient understanding of the inventive subject matter. However, it will be apparent to one of ordinary skill in the art that the invention may be practiced without including all of these specific details. Moreover, the particular embodiments described herein are provided by way of example and do not limit the scope of the invention.

The present invention applies a continuous boundary local trigonometric transform to provide analysis of a signal in a localized, patch by patch manner. To construct a continuous boundary local trigonometric transform, a set of operators are defined as follows. Let x(t) be a signal and Iₖ=(αₖ,αₖ₊1) be an interval. Then:

$${U}_{{t}_{k}} x ( t ) {=}^{Δ} U ( {r}_{k} , {α}_{k} , {∈}_{k} ) U ( {r}_{k + 1} , {α}_{k + 1} , {∈}_{k + 1} ) x ( t )$$

where U(rα∈)is a unitary operator associated with the region t ∈(α−∈,α+∈) and is defined as:

$$U ( r , α , ∈ ) x ( t ) {=}^{Δ} \{ \begin{matrix}r ( \frac{t - α}{∈} ) x ( t ) + r ( \frac{α - t}{∈} ) x ( 2 α - t ) & if α < t < α + ∈ \\ r ( \frac{α - t}{∈} ) x ( t ) - r ( \frac{t - α}{∈} ) x ( 2 α - t ) & if α - ∈ < t < α \\ x ( t ) & otherwise .\end{matrix}$$

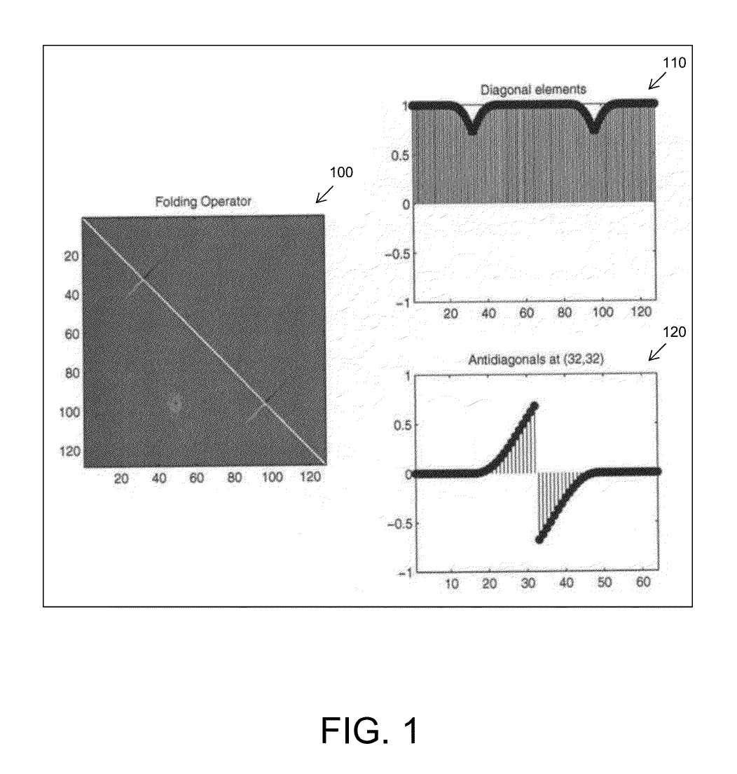

In other words, U_{I}_{ₖ} mixes, or folds, information from (α−∈,α) into (α,α+∈) and vice-versa. FIG. 1 sets forth graphs of folding operator 100, diagonal elements 110 and antidiagonals 120. In addition, the function r(t) is defined herein as a rising cutoff function, which is a smooth version (e.g., r∈C^{d}( [symbol] ) with d ∈ [symbol] )of the Heaviside step function satisfying the following condition:

$${\vert r ( t ) \vert}^{2} + {\vert r ( - t ) \vert}^{2} = 1 for all t ∈ ℝ , and r ( t ) = \{ \begin{matrix}0 & if t \leq - 1 \\ 1 & if t \leq - 1\end{matrix}$$

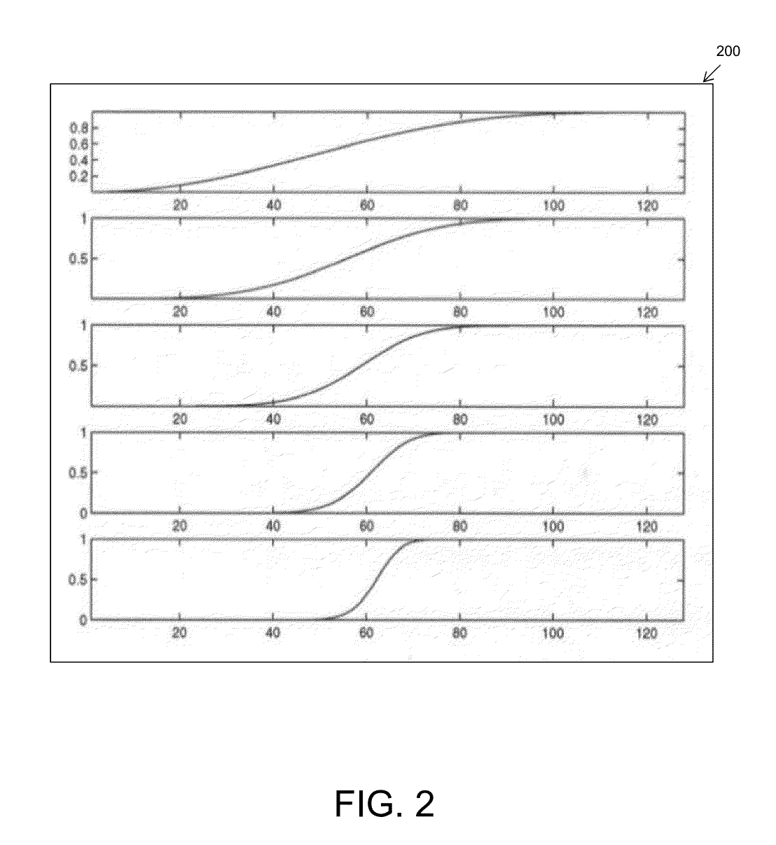

An example of a C^{m}( [symbol] ) rising cutoff function is illustrated in graph 200 of FIG. 2 and is the following iterated sine function:

$${r}_{[ m + 1 ]} ( t ) {=}^{Δ} {r}_{[ m ]} ( sin \frac{π}{2} t ) where$$

$${r}_{[ 0 ]} ( t ) {=}^{Δ} \{ \begin{matrix}0 & if t \leq - 1 \\ sin [ \frac{π}{4} ( 1 + t ) ] & if \vert t \vert < 1 \\ 1 & if t \geq 1\end{matrix}$$

Other possible choices of rising cutoff functions exist, each with varying properties. As can be seen, the folding operator U(r, α,∈) makes a signal locally even for the region (α,α+∈) and locally odd for the region (α−∈,α). Because of this polarity, the folding operator U is a cosine polarity folding operator.

The adjoint operator of U(r, α,∈) is the unitary unfolding operator:

$${U}^{*} ( r , α , ∈ ) x ( t ) {=}^{Δ} \{ \begin{matrix}r ( \frac{t - α}{∈} ) x ( t ) - r ( \frac{α - t}{∈} ) x ( 2 α - t ) & if α < t < α + ∈ \\ r ( \frac{α - t}{∈} ) x ( t ) + r ( \frac{t - α}{∈} ) x ( 2 α - t ) & if α - ∈ < t < α \\ x ( t ) & otherwise .\end{matrix}$$

The unitary unfolding operator provides a signal locally odd for the region (α,α+∈) and locally even for the region (α−∈,α). U* is therefore a sine polarity folding operator.

For the operator U_{I}_{ₖ} defined above, it is necessary that the two action regions around αₖ and αₖ₊₁ of Iₖ do not interfere; i.e., αₖ+∈_{k<α}ₖ₊₁−∈ₖ₊₁. The size of the action regions 2_{∈}_{ₖ} around the boundary αₖ, and the rising cutoff function rₖ(t) may either be dependent or independent of Iₖ . If ∈ₖ is independent of Iₖ and is held constant for all k, then U and U* are fixed folding and fixed unfolding operators, respectively. If ∈ₖ is dependent on Iₖ then U and U* are multiple folding and multiple unfolding operators, respectively.

With the folding operators as defined above, computation of discrete versions of these operators may be performed. To be specific, it may be advantageous to fold at gridpoint locations or at midpoint locations that are between gridpoints. If midpoint folding is implemented, then the rₖ consists of discrete points indexed from −R≦k≦R −1 where R is the radius of the rising cutoff function. In this case, cosine polarity folding of a function xₙ for n=0, . . . , R−1 takes the form:

\tilde{x}ₙ=rₙxₙ+r₋ₙ₋₁x₋ₙ₋₁

\tilde{x}_{N-n}=rₙx_{N-n}−r₋ₙ₋₁x_{N+n+1}

where represents the folded signal. This version of midpoint folding is straightforward to implement. However, if folding occurs at gridpoints, then an odd number of discrete values indexed from −R≦k≦R for rₖ are used. For example, if cosine folding is employed, then:

\tilde{x}ₙ=rₙxₙ+r₋ₙx₋ₙ

\tilde{x}_{N-n}=rₙ₊₁x_{N-n}−r₋ₙ₋₁x_{N+n+2} for n=0, . . . , R−2

The above operators are modified to provide the periodized unfolding operator W*_{I}_{ₖ}, defined as:

$${W}_{{I}_{k}}^{*} x ( t ) - {W}^{*} ( {r}_{k} , {α}_{k} , {ε}_{k} ) x ( t ) = \{ \begin{matrix}\begin{matrix}{r}_{k} ( \frac{t - {α}_{k}}{{ε}_{k}} ) x ( t ) - \\ {r}_{k} ( \frac{{α}_{k} - t}{{ε}_{k}} ) x ( {α}_{k} + {α}_{k + 1} - t )\end{matrix} & if {α}_{k} < t < {α}_{k} + {ε}_{k} \\ \begin{matrix}{r}_{k} ( \frac{{α}_{k + 1} - t}{{ε}_{k}} ) x ( t ) + \\ {r}_{k} ( \frac{t - {α}_{k + 1}}{{ε}_{k}} ) x ( {α}_{k} + {α}_{k + 2} - t )\end{matrix} & if {α}_{k + 1} - {ε}_{k} < t < {α}_{k + 1} \\ x ( t ) & otherwise\end{matrix} .$$

The periodized folding operator W_{I}_{ₖ} is the adjoint to the periodized unfolding operator W*_{I}_{ₖ} as:

$${W}_{{I}_{k}} x ( t ) = W ( {r}_{k} , {α}_{k} , {ε}_{k} ) x ( t ) = \{ \begin{matrix}\begin{matrix}{r}_{k} ( \frac{t - {α}_{k}}{{ε}_{k}} ) x ( t ) + \\ {r}_{k} ( \frac{{α}_{k} - t}{{ε}_{k}} ) x ( {α}_{k} + {α}_{k + 1} - t )\end{matrix} & if {α}_{k} < t < {α}_{k} + {ε}_{k} \\ \begin{matrix}{r}_{k} ( \frac{{α}_{k + 1} - t}{{ε}_{k}} ) x ( t ) - \\ {r}_{k} ( \frac{t - {α}_{k + 1}}{{ε}_{k}} ) x ( {α}_{k} + {α}_{k + 2} - t )\end{matrix} & if {α}_{k + 1} - {ε}_{k} < t < {α}_{k + 1} \\ x ( t ) & otherwise\end{matrix} .$$

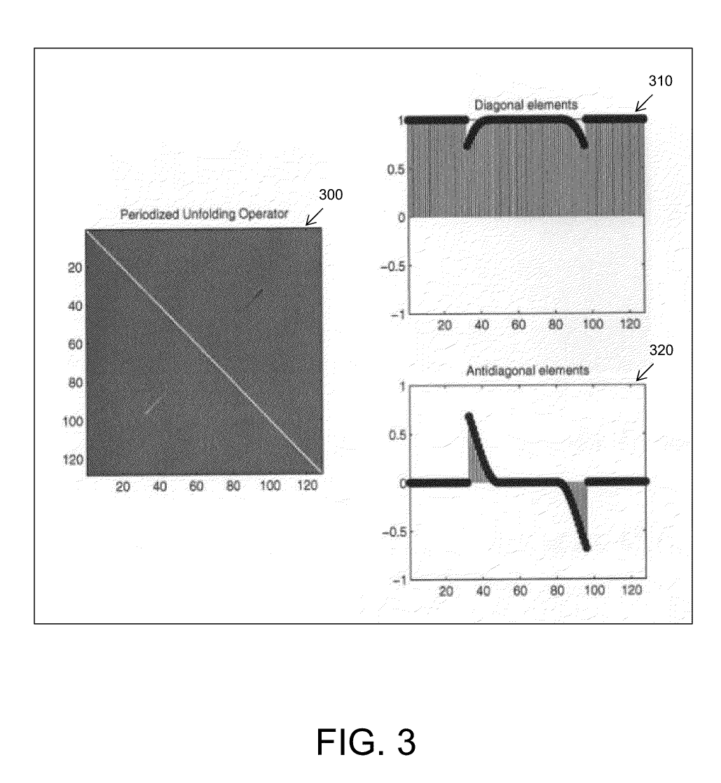

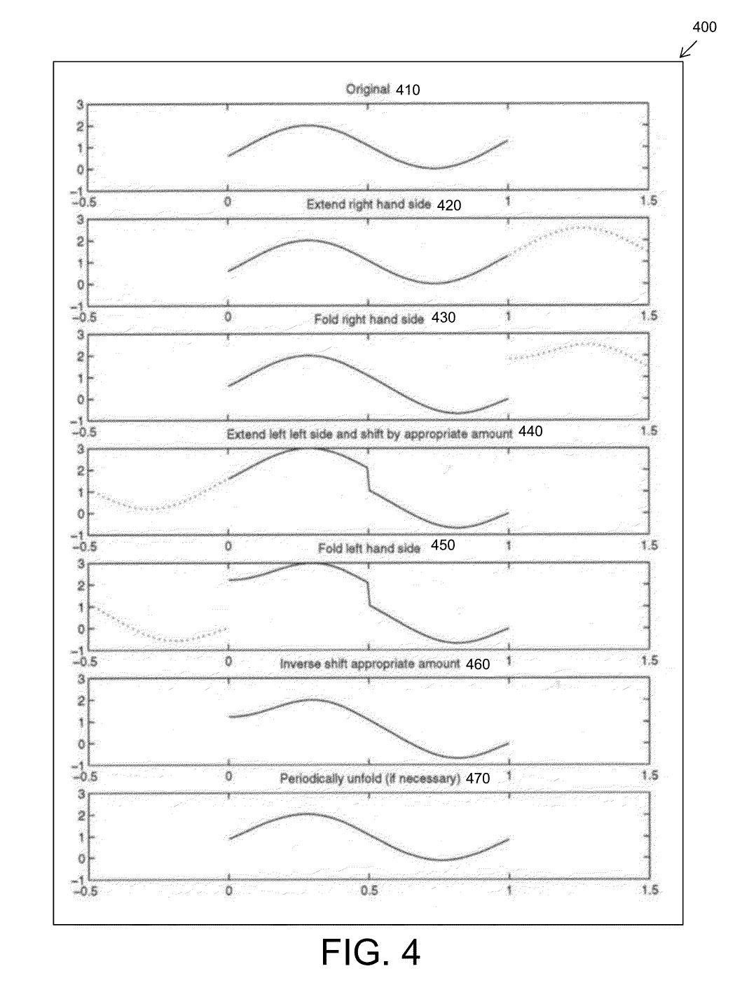

FIG. 3 sets forth graphs of periodized unfolding operator 300, diagonal elements 310 and antidiagonals 320. Continuity is forced at the boundary where folding is located to stabilize the folding process, hence the name Continuous Boundary Local Trigonometric Transform (CBLTT). For example, the CBLTT stabilizes the folding process by forcing continuity at the boundaries of the subspaces in the hierarchy of the best basis decomposition. Each subspace is considered disjoint to one another such that information is not mixed between adjacent intervals during the folding procedure, and an artificial extension is created in a continuous fashion at the boundary of each subspace. For example, FIG. 4 sets forth graphs 400 of periodization of interval 410 using isometric shift operators. A right hand side extension 420 is added to original subspace interval 410. After the right hand side is folded 430, the right hand extension is discarded and the left hand side is extended and shifted 440. The left hand side is folded 450, and thereafter the left hand extension discarded. Then, an inverse shift 460 is performed. Finally, the interval may be periodically unfolded 470 if so desired.

While there are an infinite number of possible continuous extensions, it is necessary to create one with properties for stable inversion. The reason for this requirement is that after folding is performed in the forward direction, the folded extension is discarded. Thus, inverse folding cannot be performed unless an inverse formula can be derived from the structure of the artificial extension. Finding a stable inverse is not a simple task. To begin with, an inverse does not always exist in the continuous case. However, this issue may be circumvented for a discrete setting.

In one embodiment, an even extension with midpoint folding is constructed as follows. Let x, be a function of N+1 discrete points indexed from 0to N. For simplicity, let R be the radius of the rising cutoff function such that

$$R \leq \frac{N + 1}{2} ,$$

and let n=0, . . . , R−1 for all of the following formulas.

Then, one embodiment of the discrete even extension can be constructed by letting x₋ₙ₋₁₌xₙ for values of the extension to the left of x_{q}, and x_{N+n+1=}x_{N-n} for values of the extension to the right of xₙ. Accordingly, folding at the left hand edge becomes \tilde{x}ₙ=(rₙ +r₋ₙ₋₁) and folding at the right hand edge is represented by \tilde{x}_{N-n}=(rₙ−r₋ₙ₋₁)x_{N-n}.

$${x}_{n} = \frac{{\tilde{x}}_{n}}{{r}_{n} + {r}_{- n - 1}} and {x}_{N - n} = \frac{{\tilde{x}}_{N - n}}{{r}_{n} - {r}_{- n - 1}} .$$

Inversion simply becomes

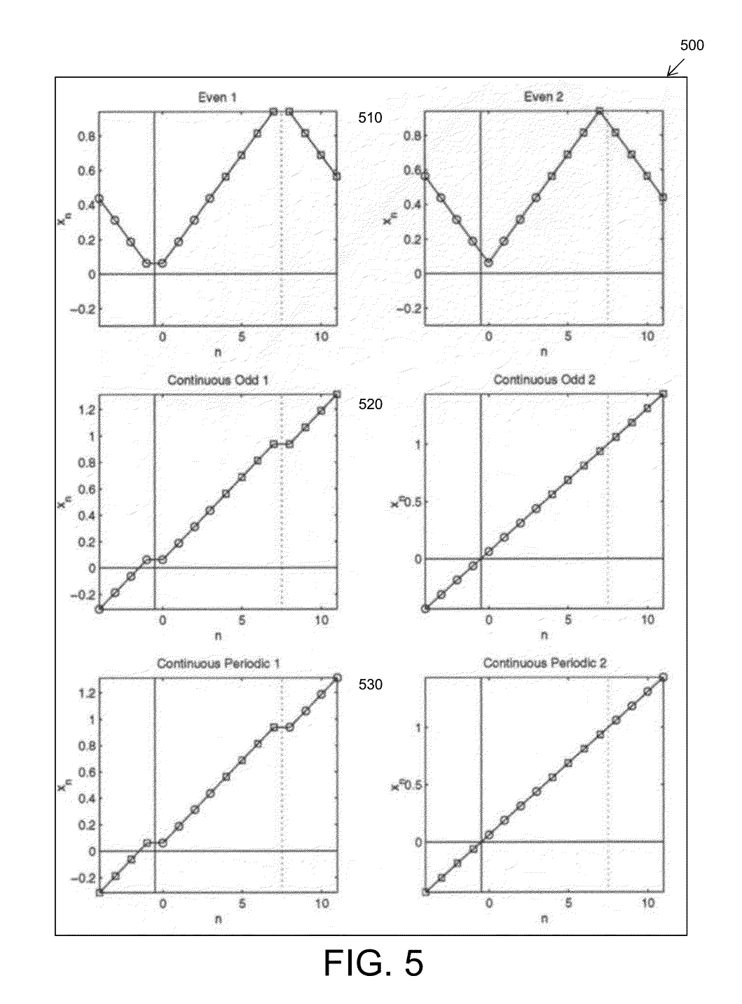

Next, two methods are disclose that each guarantee isometry. The first method begins with applying a first extension as an even reflection about a first boundary of a subspace interval of a signal. Odd polarity folding at the first boundary of the subspace is performed, and the folded first extension is discarded. A second extension is applied as an even reflection about a second boundary of the subspace, and a predetermined amount s is added to the signal and the second extension. Even polarity folding at the second boundary of the subspace is performed. Thereafter, the predetermined amount s is subtracted from the signal and the second extension to preserve continuity throughout the interval. The folded second extension is then discarded. Periodized unfolding may be performed if desired, by for example, projecting onto a Fourier basis. FIG. 5 sets forth graphs of extensions 500 including even extensions 510, continuous odd extensions 520 and continuous periodic extensions 530 using the first method.

A generalized isometric folding formula for the left half interval is:

$${\tilde{x}}_{s , n} = \underbrace{( {r}_{n} + {r}_{- n - 1} ) {x}_{n}}_{{\tilde{x}}_{n}} + s \underbrace{( {r}_{n} + {r}_{- n - 1} - 1 )}_{{λ}_{n}}$$

For inversion:

$${x}_{n} = \frac{{\tilde{x}}_{s , n}}{\underbrace{{r}_{n} + {r}_{- n - 1}}_{{z}_{n}}} - s \frac{{λ}_{n}}{\underbrace{{r}_{n} + {r}_{- n - 1}}_{{α}_{n}}} .$$

The value of s may be determined via a root finding method, but since these are slow to converge, an explicit formula is provided using the definition of an isometry.

For the forward direction:

$$s = \frac{- {\sum }_{n = 0}^{R - 1} {\tilde{x}}_{n} {λ}_{n} \pm \sqrt{\begin{matrix}{( {\sum }_{n = 0}^{R - 1} {\tilde{x}}_{n} {λ}_{n} )}^{2} - \\ {\sum }_{n = 0}^{R - 1} {λ}_{n}^{2} {\sum }_{n = 0}^{R - 1} ( {\tilde{x}}_{n}^{2} + {\tilde{x}}_{N - n}^{2} - {x}_{n}^{2} - {x}_{N - n}^{2} )\end{matrix}}}{{\sum }_{n = 0}^{R - 1} {λ}_{n}^{2}}$$

For the inverse direction:

$$s = \frac{\begin{matrix}- {\sum }_{n = 0}^{R - 1} {α}_{n} {z}_{n} \pm \\ \sqrt{\begin{matrix}{( {\sum }_{n = 0}^{R - 1} {α}_{n} {z}_{n} )}^{2} - \\ {\sum }_{n = 0}^{R - 1} {α}_{n}^{2} {\sum }_{n = 0}^{R - 1} ( {z}_{n}^{2} + {z}_{N - n}^{2} - {\tilde{x}}_{s , n}^{2} - {\tilde{x}}_{s , N - n}^{2} )\end{matrix}}\end{matrix}}{{\sum }_{n = 0}^{R - 1} {α}_{n}^{2}} .$$

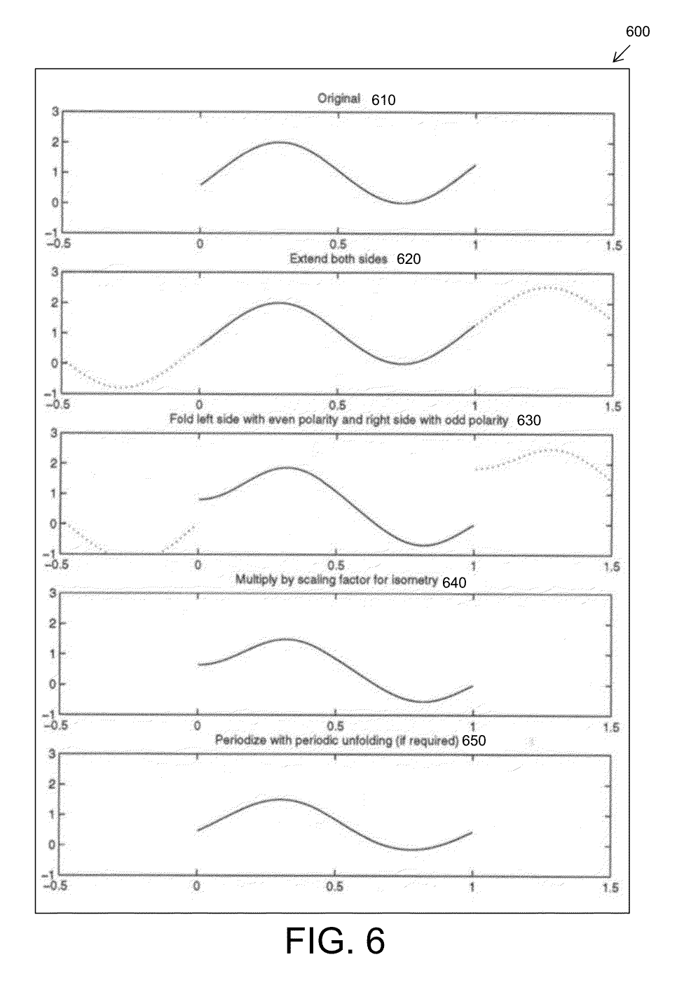

The second method for guaranteeing an isometry is to globally scale the data. FIG. 6 sets forth graphs 600 of periodization of interval 610. For a subspace of original signal 610, the first step 620 is applying a first extension to a first boundary and a second extension to a second boundary of the global subspace of the signal in a continuous fashion. Folding 630, such as standard folding, is performed at the first boundary with even polarity and the second boundary with odd polarity. The first extension and the second extension are then discarded. The results are then globally scaled 640 by a predetermined scale factor p to preserve the isometry. Periodized unfolding 650 may be performed if desired, by for example, projecting onto a Fourier basis.

The scale factor p for the forward direction is:

$$p = \sqrt{\frac{{\sum }_{n = 0}^{N} {x}_{n}^{2}}{{\sum }_{n = 0}^{N} {\tilde{x}}_{n}^{2}}}$$

The scale factor p for the inverse direction is:

$$p = \sqrt{\frac{{\sum }_{n = 0}^{N} {\tilde{x}}_{p , n}^{2}}{{\sum }_{n = 0}^{N} {z}_{n}^{2}}}$$

where zₙ is the result of applying the standard continuous unfolding routines to \tilde{x}²_{p,n.}

A continuous boundary local trigonometric transform may thus be instantiated by applying a first extension to a first boundary and a second extension to a second boundary of a global subspace of a signal. Standard isometric folding is performed at the first boundary and the second boundary of the subspace such as with midpoint cosine polarity with full folding. The first extension and the second extension of the subspace are discarded. The subspace results are scaled by a value p and the DCT-IV of the subspace is taken and the results are stored in a best basis tree. The scaled subspace is split in half, and the steps of applying extensions through scaling the subspace are performed recursively. When a bottom of the best basis tree is reached, a best basis algorithm is performed on the best basis tree using a comparison metric such as sparsity, entropy, etc.

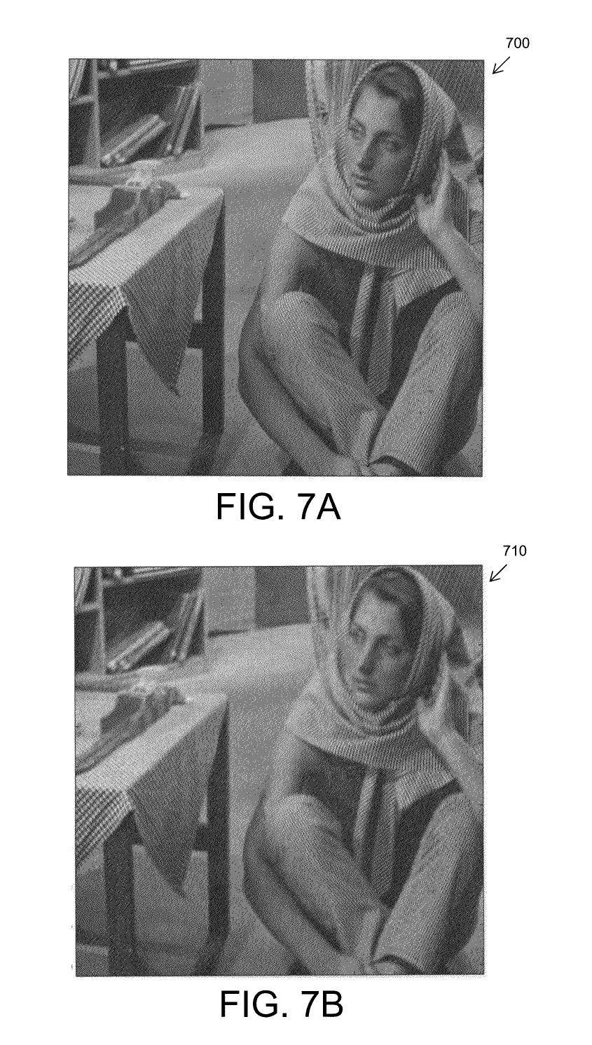

All of these methods may be applied to higher dimensional data (e.g., images, video, etc.) by applying them as a tensor product. For example, FIGS. 7A-7B are images illustrating compression and show the continuous boundary local trigonometric transform used in compression. FIG. 7A is the original image whereas FIG. 7B is the same image having 20:1 compression when using the CBLTT.

In other embodiments, information may be encoded so as to be hidden in other information by utilizing the CBLTT. A first signal to be hidden within a second signal may be provided by converting the second signal into a frequency domain using the CBLTT as discussed above. The first signal is then broken up and encoded into different sections of the transformed second signal. The frequency domain second signal encoded with the first signal is then transformed back into the time domain using an inverse CBLTT on each of the sections.

The second signal encoded with the first signal is recovered by performing a CBLTT transform from time domain to frequency domain. The first signal is then extracted from the frequency domain and an inverse CBLTT may be performed to recover the first signal.

The CBLTT is effective in embedding large quantities of data in a manner imperceptible to the human eye. The methods discussed above are further robust enough to be implemented in various environments to overcome associated channel noise. The methods are easily adapted to existing manufacturing techniques and are difficult to counterfeit.

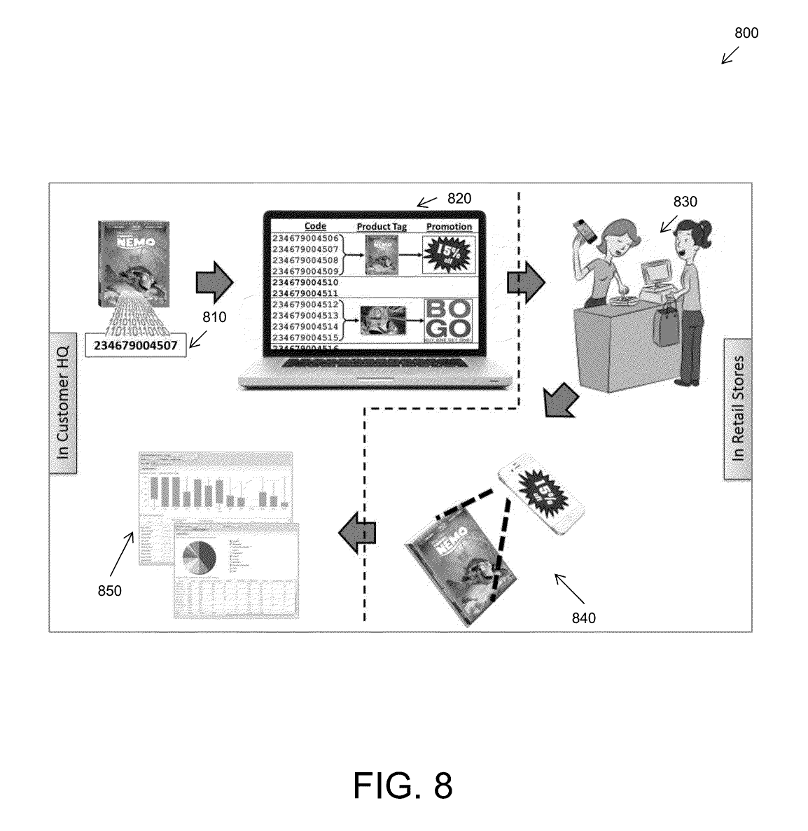

FIG. 8 is a conceptual diagram illustrating a system for embedding and retrieving hidden information. Hidden information is embedded into media such as product packaging including text and image at step 810. The information may be a barcode, a character string, or any other format, but is imperceptible to the human eye when embedded. In FIG. 8, character string data 234679004507 is hidden within the image of printed product packaging using CBLTT. The CBLTT data may be associated with a product at step 820 for marketing, supply chain tracking, authentication, or other purposes. In FIG. 8, the hidden CBLTT data within the product packaging is associated with a discount promotion for the product.

At a retail store, a consumer that selects the product for purchase at step 830 may be offered a discount if a mobile device scans the product packaging and extracts the hidden CBLTT data at step 840. The mobile device captures an image of the product packaging and determines if the image contains hidden CBLTT data using the inverse CBLTT. If so, the discount promotion may be offered to the user. In other embodiments, decoding of the hidden CBLTT data may confirm authenticity of the product, return an image, video, text, audio, and/or hyperlink to the mobile device, and/or return software to the mobile device which directs the phone to act on the software, etc. At step 850, the hidden CBLTT data and associated data gathered by the application may then be transmitted to an external server of the product manufacturer, retailer, etc. for consumer analytics purposes and may be used, for example, to generate shopping trend reports.

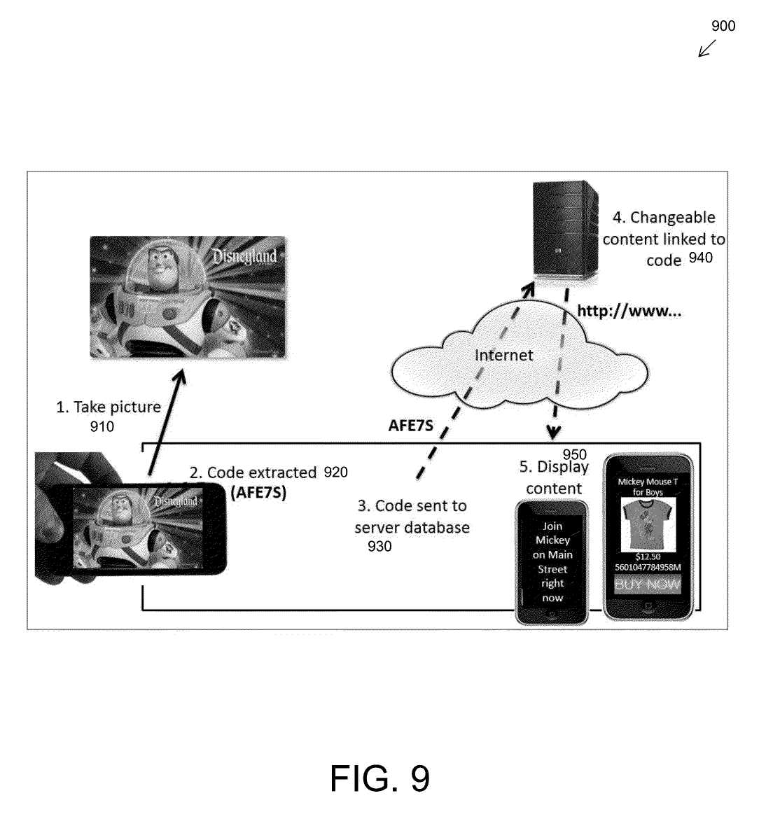

FIG. 9 is a conceptual diagram illustrating a system for embedding and retrieving hidden information. Printed media, such as a ticket, may include an image that is embedded with hidden CBLTT data. In FIG. 9, a user operates a mobile device to capture an image of the ticket at step 910 to extract the hidden CBLTT data “AFE7S” at step 920. The mobile device transmits the code at step 930 over a communication network, such as the internet, to a server. The server at step 940 may determine a response based on the hidden CBLTT data, such as returning a link to content for display on the mobile device. At step 950, the mobile device receives the link, which in this case is a link to a message related to the ticket or a link to purchase a related product. The server may provide a dynamic response to the received extracted hidden code.

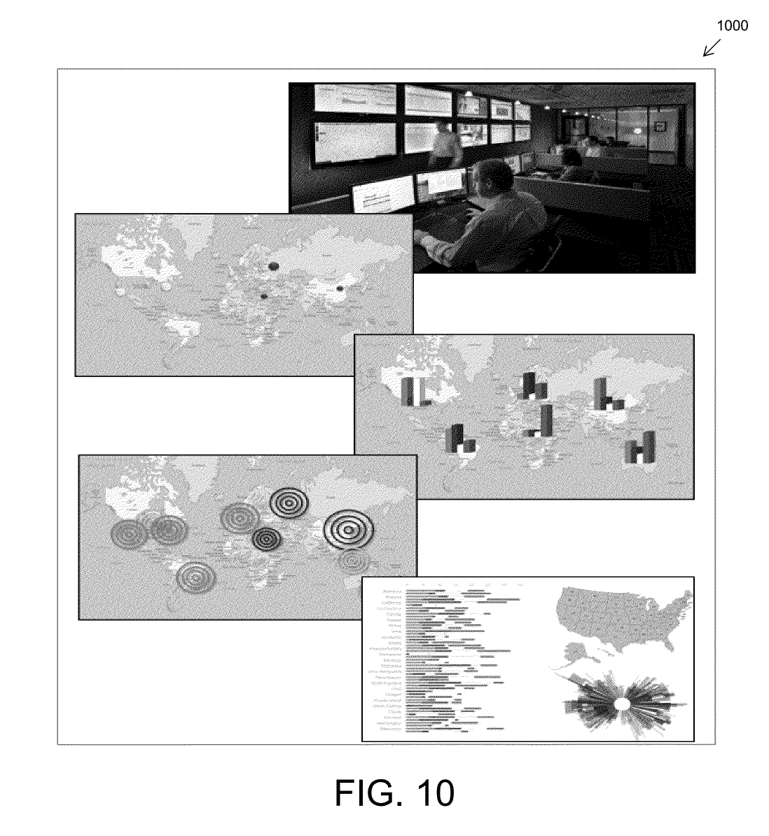

The extracted CBLTT data and associated data transmitted by the mobile device may undergo complete back-end analytics. For example, the hidden CBLTT data transmitted to a network operations center may be analyzed to track hidden CBLTT data usage on a worldwide basis as shown in FIG. 10, where demographic, geographic, time response information, and other analytic information may be determined and displayed. The network operations center may also push notifications to customers in questionable areas. The analytics provided enabled by the hidden CBLTT data allows for more precise targeted marketing in one implementation.

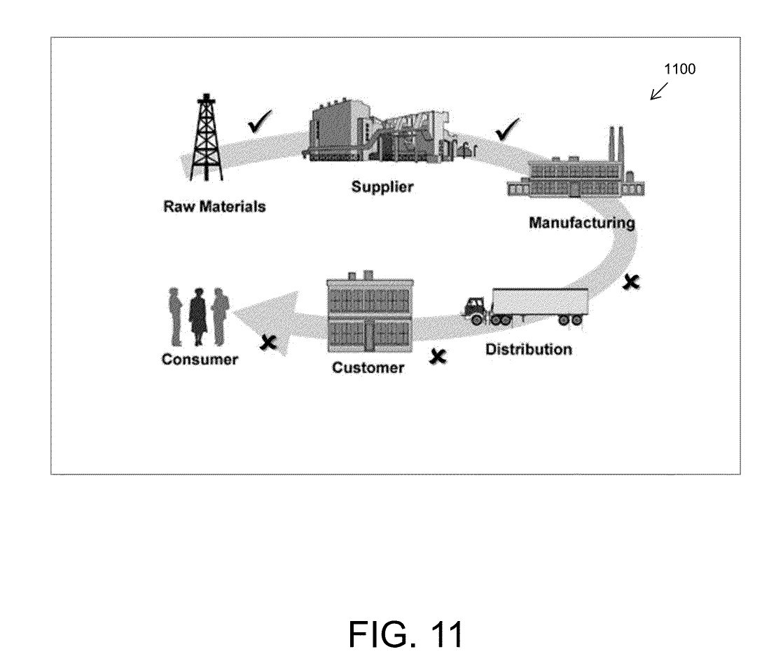

In another implementation, the hidden CBLTT data embedded into a product provides supply chain tracking and authentication. Each level of a supply chain (e.g., raw materials, supplier, manufacturing, distribution, customer and consumer) may include a product or article embedded with the hidden CBLTT data. For example, the product at each level of the supply chain may be marked with different hidden CBLTT data, thereby allowing precise tracking and authentication of the product throughout the supply chain. In supply chain 1100 of FIG. 11, the product marked from the supplier and the raw materials includes the predetermined hidden CBLTT data, thereby indicating that the product received from those sites are authentic. The product tracking and authentication data may be quickly checked by an application of a mobile device. However, the product received from a manufacturing site, and thereafter down the supply chain that do not include the hidden CBLTT data indicate that the product from manufacturing is fraudulent. Using the hidden CBLTT data provides a discreet, yet difficult to counterfeit tracking authentication system.

As shown in FIGS. 8, 9 and 11, the hidden CBLTT data may be embedded within product packaging for marketing, authentication and tracking. The design and look of any image may be retained when embedded with the hidden CBLTT data, and is difficult to counterfeit. Performing the inverse CBLTT on the captured image also allows immediate authentication and marketing to a user. The image capture, decoding and recording of the CBLTT data allows user actions to be tracked at a centralized database for real-time analytics and provides the ability to push notifications and information to interested users based on the CBLTT data.

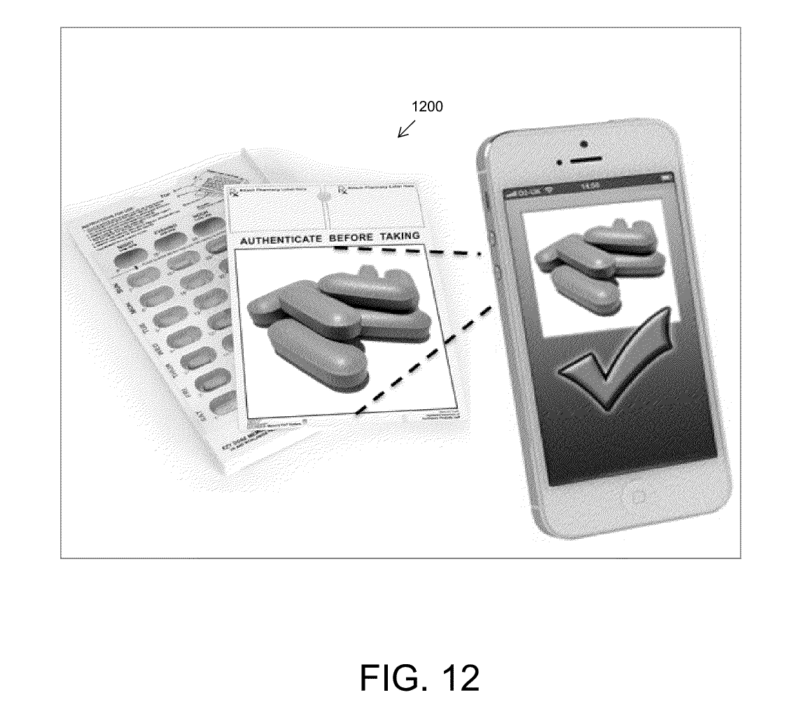

FIG. 12 illustrates an embodiment where a blister pack is embedded with hidden CBLTT data used to ensure authenticity. In one embodiment, a user captures an image of the blister pack with a mobile device, and then runs an application on the device that detects if the image includes hidden CBLTT data. If so, the CBLTT data is extracted and the user is provided an indication of whether the blister pack product is authentic or fraudulent. The hidden CBLTT data may similarly be embedded within any type of product packaging.

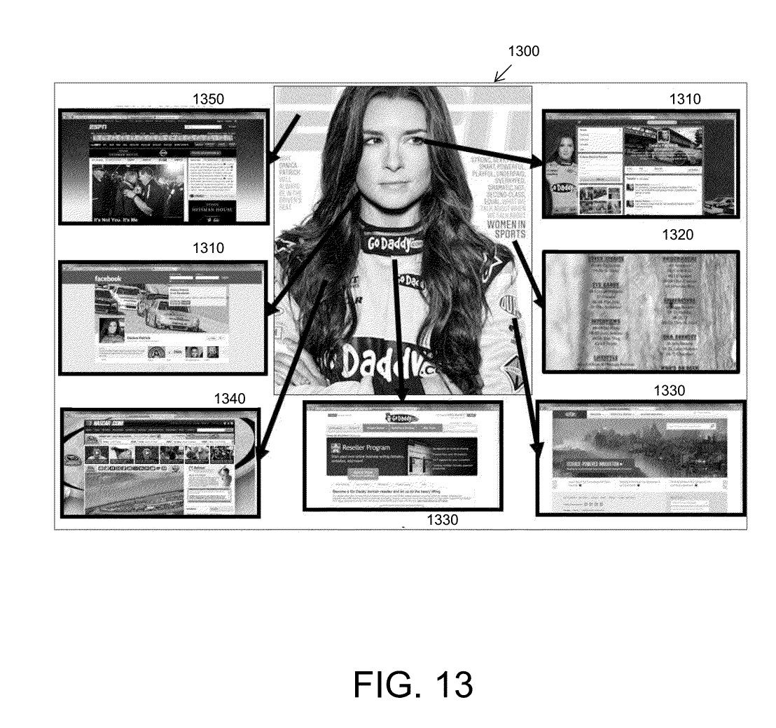

In the embodiment of FIG. 13, printed media, including magazine 1300, may include a plurality of hidden CBLTT data for any of authentication, tracking and marketing. For example, hidden CBLTT data encoded within a face portion of an image may direct a mobile device to a website or social media site 1310 associated with the face. Similarly, extraction of hidden CBLTT data within magazine text and related imagery may direct the mobile device to magazine website 1350 or magazine contents 1320. Other portions of the printed media, including those displaying corporate logos, may include hidden CBLTT data that directs the mobile device to the corresponding corporate websites 1330 or related websites 1340 when extracted.

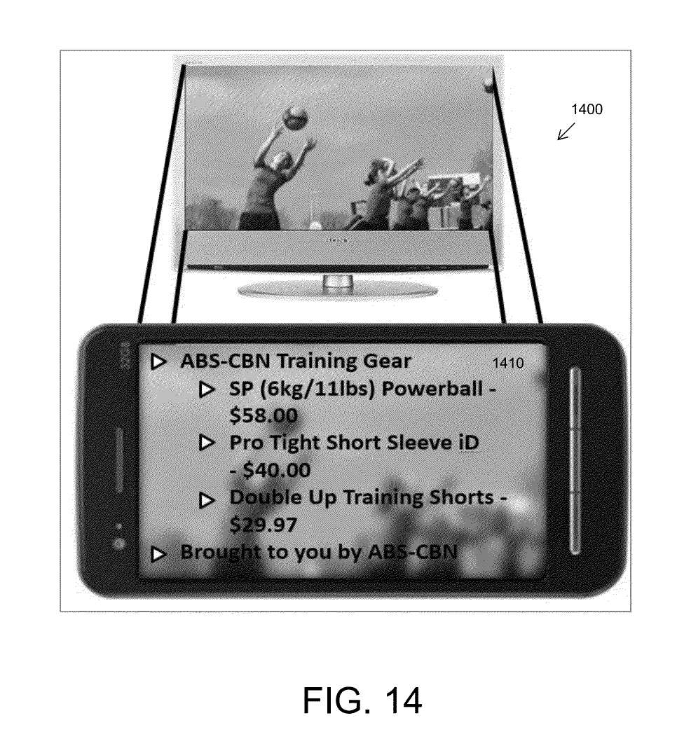

FIG. 14 illustrates hidden data on a display device. Display device 1400, such as a television, may output an image/video including hidden CBLTT data for any of authentication, tracking and marketing. A mobile device user captures an image displayed by the display device when they see/hear an item they are interested in, such as clothing or a song. Hidden CBLTT data encoded within the displayed image captured by a mobile device may then direct the mobile device to display a list 1410 of purchasable items within the image. The device may open a website with more information about the products associated with the captured image, and may provide information on where to buy the products and similar products or provide those products directly. The hidden CBLTT data may also be embedded within a webpage.

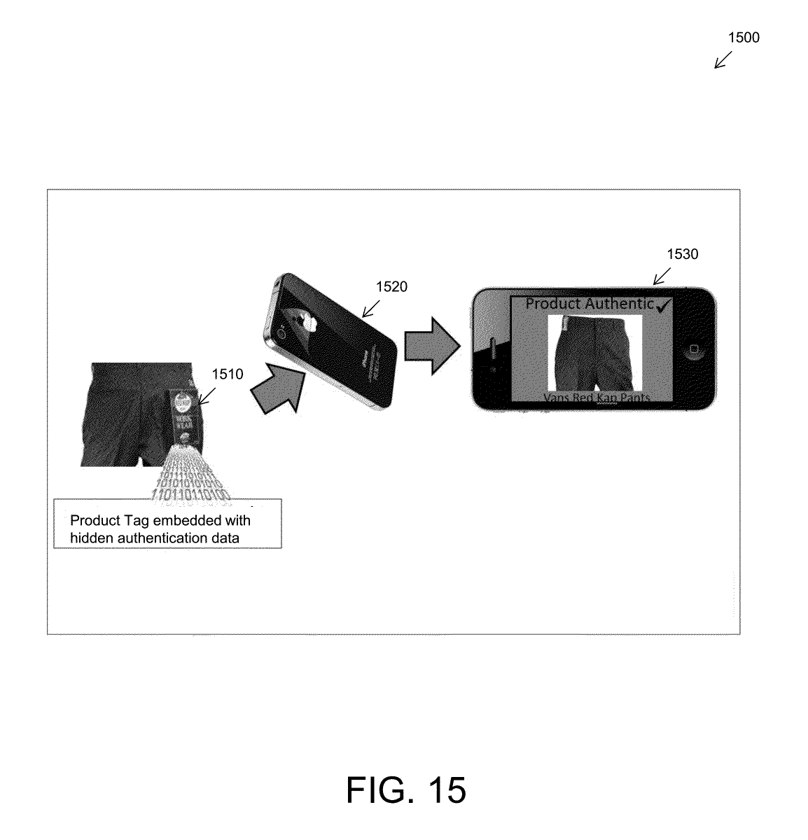

FIG. 15 illustrates a system 1500 including hidden data within a product hang-tag 1510 attached to a product. Product tag 1510 may include hidden CBLTT data for any of authentication, tracking and marketing. For example, hidden CBLTT data encoded within product tag 1510 that is captured by mobile device 1520 may direct the mobile device to determine whether the product tag is authentic or counterfeit and provide a display 1530 of the result.

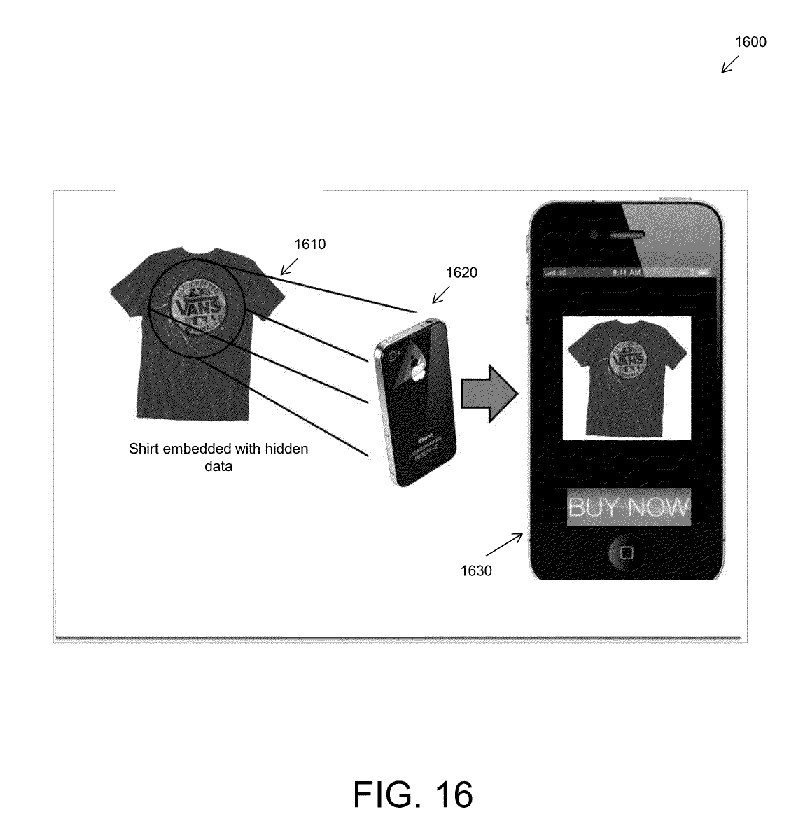

FIG. 16 illustrates a system 1600 including hidden data within an article of clothing. Shirt 1610 may include hidden CBLTT data for any of authentication, tracking and marketing. For example, hidden CBLTT data encoded within shirt 1610 that is captured by mobile device 1620 may direct the mobile device to display product information 1630 for purchase of shirt 1610. In place of a shirt, the article may be a metal object, wristband, machine part or other physical object.

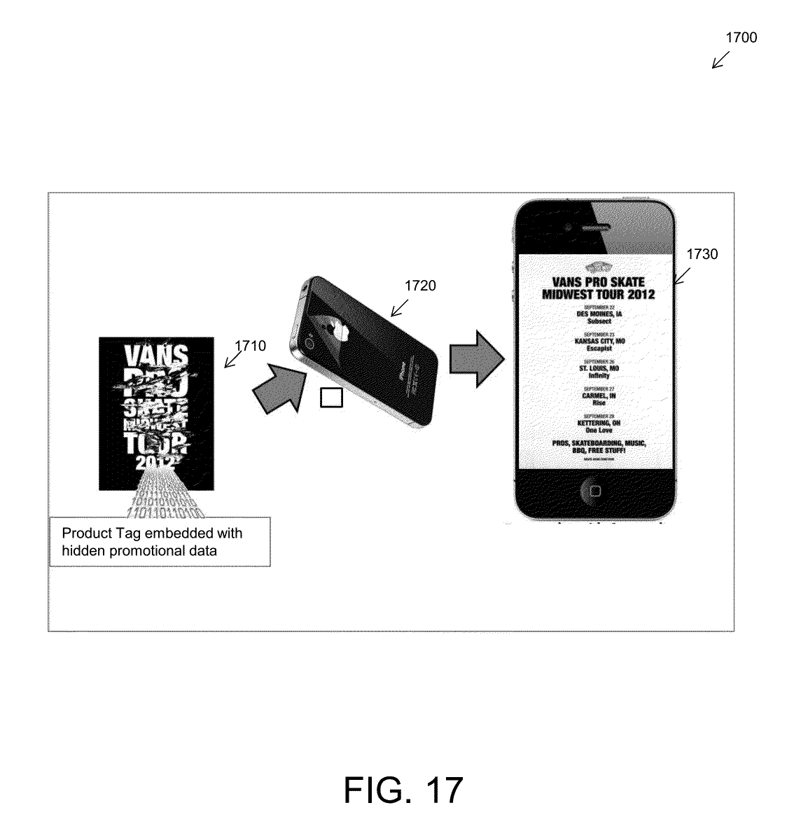

FIG. 17 illustrates a system 1700 including hidden data within printed media 1710. Printed media 1710, such as an advertisement, poster, billboard, window tint, etc., may include hidden CBLTT data for any of authentication, tracking and marketing. For example, hidden CBLTT data encoded within printed media 1710 that is captured by mobile device 1720 may direct the mobile device to provide a display 1730 of promotional material associated with printed media 1710.

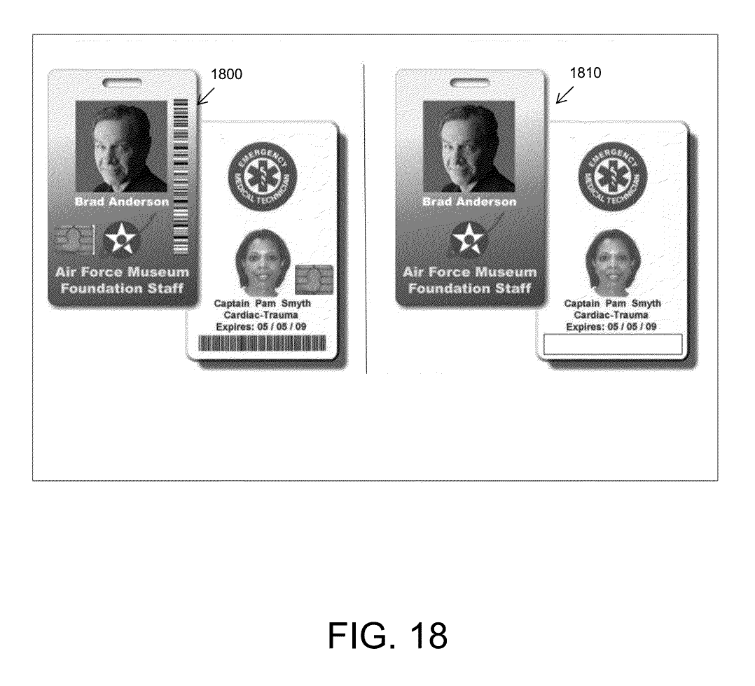

FIG. 18 illustrates identification badges 1800, 1810. Barcodes printed on badge 1800 may provide additional information to that of the printed text and printed images. However, the barcodes within badges 1800 are unattractive and take up valuable space. On the other hand, badge 1810 includes hidden data for any of authentication, tracking and marketing. For example, hidden CBLTT data encoded within badge 1810 allows badge 1810 to provide at least the same amount of information as the barcode, but to do so covertly without taking up space on the badge.

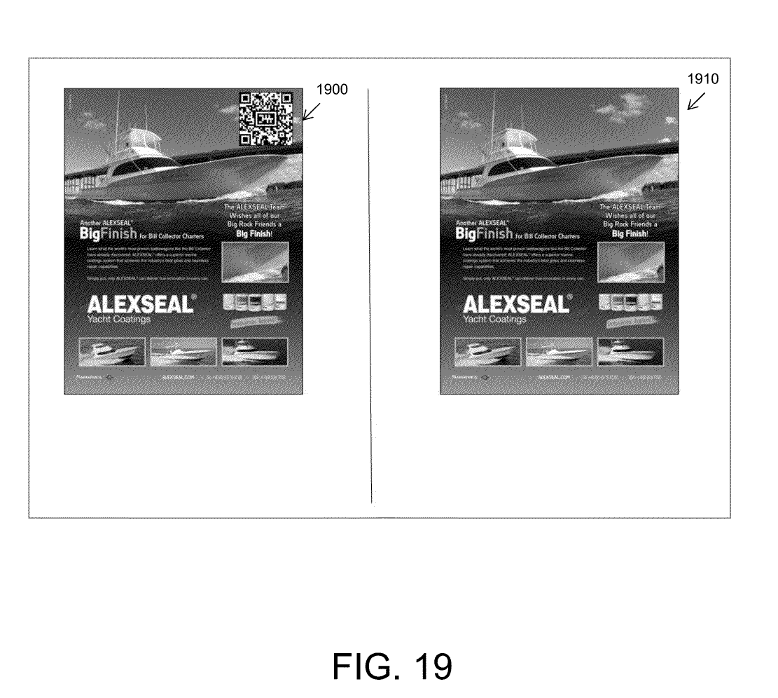

FIG. 19 illustrates advertisements 1900, 1910. A QR code printed on advertisement 1900 may provide additional information to that of the printed text and printed images. However, the QR code within advertisement 1900 is unattractive and takes up valuable space. On the other hand, advertisement 1910 includes hidden data for any of authentication, tracking and marketing. For example, hidden CBLTT data encoded within advertisement 1910 provides at least the same amount of information as the QR code, but does so covertly without taking up space on the advertisement. Thus, the invention provides the ability to embed hidden information into any object or file that currently uses visual barcodes, while retaining the same functionality and use of a visible barcode.

The system and method of the present invention described herein may be implemented in any type of computer system or programming or processing environment including personal computing devices, smart-phones, pad computers, cameras, scanners, augmented reality systems and the like. The methods described herein may be implemented as instructions in software code or hardware and may be executed by any suitable microprocessor, central processing unit (CPU) or the like, and may be embodied in any form of computer program product, meaning any medium or memory such as RAM, ROM or the like, that is configured to store or transport computer readable code, or in which computer readable code may be embedded.

Application code may be embodied in any form of computer program product. A computer program product comprises a medium configured to store or transport computer readable code, or in which computer readable code may be embedded. Some examples of computer program products are CD-ROM disks, ROM cards, floppy disks, magnetic tapes, computer hard drives, servers on a network, and carrier waves.

As disclosed herein, features consistent with the present inventions may be implemented via computer-hardware, software and/or firmware. For example, the systems and methods disclosed herein may be embodied in various forms including, for example, a data processor, such as a computer that also includes a database, digital electronic circuitry, firmware, software, computer networks, servers, or in combinations of them. Further, while some of the disclosed implementations describe specific hardware components, systems and methods consistent with the innovations herein may be implemented with any combination of hardware, software and/or firmware. Moreover, the above-noted features and other aspects and principles of the innovations herein may be implemented in various environments. Such environments and related applications may be specially constructed for performing the various routines, processes and/or operations according to the invention or they may include a general-purpose computer or computing platform selectively activated or reconfigured by code to provide the necessary functionality. The processes disclosed herein are not inherently related to any particular computer, network, architecture, environment, or other apparatus, and may be implemented by a suitable combination of hardware, software, and/or firmware. For example, various general-purpose machines may be used with programs written in accordance with teachings of the invention, or it may be more convenient to construct a specialized apparatus or system to perform the required methods and techniques.

It should also be noted that the various logic and/or functions disclosed herein may be enabled using any number of combinations of hardware, firmware, and/or as data and/or instructions embodied in various machine-readable or computer-readable media, in terms of their behavioral, register transfer, logic component, and/or other characteristics. Computer-readable media in which such formatted data and/or instructions may be embodied include, but are not limited to, non-volatile storage media in various forms (e.g., optical, magnetic or semiconductor storage media) and carrier waves that may be used to transfer such formatted data and/or instructions through wireless, optical, or wired signaling media or any combination thereof. Examples of transfers of such formatted data and/or instructions by carrier waves include, but are not limited to, transfers (uploads, downloads, e-mail, etc.) over the Internet and/or other computer networks via one or more data transfer protocols (e.g., HTTP, FTP, SMTP, and so on).

The foregoing description, for purpose of explanation, has been described with reference to specific embodiments. However, the illustrative discussions above are not intended to be exhaustive or to limit the invention to the precise forms disclosed. Many modifications and variations are possible in view of the above teachings. The embodiments were chosen and described in order to best explain the principles of the invention and its practical applications, to thereby enable others skilled in the art to best utilize the invention and various embodiments with various modifications as are suited to the particular use contemplated.

1. A method for digital signal compression executed by a processor comprising:
a) applying a first extension to a first boundary and a second extension to a second boundary of a global subspace of a signal;
b) performing isometric folding at the first boundary and the second boundary of the subspace;
c) discarding the first extension and the second extension of the subspace;
d) scaling the subspace;
e) applying a discrete transform to the subspace to generate a transformed subspace;
f) storing the transformed subspace in a best basis tree;
g) halving the scaled subspace of step d) into a first half subspace and a second half subspace;
h) recursively repeating steps a) through f) on the first half subspace and the second half subspace; and
i) applying a metric for a best basis algorithm performed on the best basis tree when a bottom of the best basis tree is reached.

2. The method of claim 1, wherein the folding is performed at a gridpoint or a midpoint.

3. The method of claim 1, wherein the discrete transform is DST-IV using sine polarity or DCT-IV using cosine polarity.

4. The method of claim 1, wherein the folding is full, fixed or multiple.

5. The method of claim 1, further comprising:
performing periodized folding with a fast Fourier transform after step d).

6. The method of claim 1, further comprising:
applying a complex valued or a real-valued fast Fourier transform to the signal before step a).

7. The method of claim 1, wherein the best basis metric includes sparsity and entropy.

8. The method of claim 1, wherein the discrete transform is one of DCT-I, DCT-II, DCT-III, DST-1, DST-II, DST-III and the folding is mixed polarity or hybrid polarity.

9. The method of claim 1, wherein step b) performs shift isometric folding.

10. The method of claim 1, wherein one of the first extension and the second extension is used in the folding and the unfolding.

11. The method of claim 1, storing the first extension and the second extension, a shift value of the isometric folding, and a scale value of the scaling.

12. The method of claim 1, wherein the isometric folding includes a folding operator determined as a function of a rising cutoff function.

13. The method of claim 1, further comprising:
applying a result of step i) as a tensor product to higher dimensional data.

14. The method of claim 13, wherein the higher dimensional data includes at least one of audio, image and video data.

15. The method of claim 1, further comprising:
performing an inverse operation to each of steps a) through i).

16. The method of claim 1, wherein a predetermined set of transform coefficients of the transformed subspace are discarded and a remaining set of the transform coefficients are used to invert the transformed subspace to reconstruct a compressed version of the digital signal.

17. A method for embedding hidden data into an object comprising:
a) applying a first extension to a first boundary and a second extension to a second boundary of a global subspace of a digital signal of the object;
b) performing isometric folding at the first boundary and the second boundary of the subspace;
c) discarding the first extension and the second extension of the subspace;
d) scaling the subspace;
e) applying a discrete transform to the subspace to generate a transformed subspace;
f) modifying transform coefficients of the transformed subspace to include the hidden data such that transforming the modified transform coefficients generates a modified digital signal;
g) storing the transformed subspace in a best basis tree;
h) halving the scaled subspace of step d) into a first half subspace and a second half subspace;
i) recursively repeating steps a) through f) on the first half subspace and the second half subspace; and
j) applying a metric for a best basis algorithm performed on the best basis tree when a bottom of the best basis tree is reached.

18. The method of claim 17, wherein the object is any of printed media, clothing, a metal object, audio data, image data, video data, a webpage, product packaging, product hang-tag, wristband, blister packaging, machine part, billboard, and window tint.

19. A method of extracting hidden data in an object by a device comprising:
capturing an image of the object;
converting the image to a digital signal;
a) applying a first extension to a first boundary and a second extension to a second boundary of a global subspace of the digital signal of the image of the object;
b) performing isometric folding at the first boundary and the second boundary of the subspace;
c) discarding the first extension and the second extensions of the subspace;
d) scaling the subspace;
e) applying a discrete transform to the subspace to generate a transformed subspace;
f) storing the transformed subspace in a best basis tree;
g) halving the scaled subspace of step d) into a first half subspace and a second half subspace;
h) recursively repeating steps a) through f) on the first half subspace and the second half subspace;
applying a metric for a best basis algorithm performed on the best basis tree when a bottom of the best basis tree is reached; and
extracting the hidden data from the transformed subspace.

20. The method of claim 19, wherein the device is a mobile device.
